(19) United States
(12) Patent Application Publication
(10) Pub. No.: US 2003/0204425 A1
(43) Pub. Date: Oct. 30, 2003

(54) Method and apparatus for creating and processing applications

(76) Inventors: David V. Kennedy, Washington Crossing, PA (US); John J. Lambert, Trenton, NJ (US); Thomas Perro, Trenton, NJ (US); Jimmy P. Molina, Lawrenceville, NJ (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/136,194

(22) Filed: Apr. 30, 2002

(51) Int. Cl. G06F 17/60

(52) U.S. Cl. 705/7; 705/11; 345/825

(57) ABSTRACT

A method for electronically facilitating an application process comprises creating a customized application for a data requester, the customized application being accessed via an Internet link to which access is controlled, granting access to the customized application to a specified data provider, accepting data from the specified data provider, providing an information management tool to the data requester, the information management tool being operable to manipulate the data from the specified data provider, and exchanging data between the data provider and the data requester. The present invention may be implemented by a computer carrying an ordered set of instructions which, when executed, perform the above-identified method.

### FIELD OF THE INVENTION

The present invention relates generally to computerized application transactions and more particularly to creating, controlling access to, and manipulating data entered into an online application.

### BACKGROUND

Employers incur great expense when hiring new personnel. In a typical hiring process, the employer advertises a job opening and applicants respond by submitting a resume. The employer reviews the resumes and selects those applicants that meet the minimum job requirements. The employer calls the selected applicants in for a personal interview and asks the selected applicants to complete an employment application. The employer examines the employment applications and orders third party services to verify the truthfulness of the information contained in the applicant's resume and employment application. Third party services may include criminal background checks, driver's license checks, credit report requests, education credential verifications, reference checks, and previous employment verifications, among others. Relying on the selected applicant's resume, personal interview, employment application, and third party service results, the employer elects to make or withhold an offer of employment to an applicant.

Each stage of the hiring process is impeded by the lack of a centralized system for facilitating the application process. The lack of a centralized system may require multiple entry of the same data for different stages of the application process. For example, during the personal interview, the applicant fills out a paper employment application. A company employee enters the job applicant data from the paper employment application into the company's computer system. When requesting a third party service for the applicant, such as a criminal records check, the company may print a hard copy of the employment application and fax the employment application to the third party service provider. An employee of the third party service provider may then re-enter the job applicant data into the third party service provider's computer system. The results from the criminal background check may be entered into the third party service provider's computer. The third party service provider may fax the results to the company. Again, a company employee enters the results of the criminal background check into the company's database.

The lack of a centralized system may impede the distribution of information within a company. For example, an applicant may be qualified for several positions, each in a different department, within the same company. Thus, it is desirable for each department manager to review the applicant's employment application, resume, etc. However, due to the lack of a centralized system, each department manager cannot access this information. Thus, the human resources department must send paper copies of the applicant's information to each department manager. Furthermore, the human resources department must enter any comments made by a department manager into the company's database.

The lack of a centralized system increases the time needed to process an application, wastes manpower, increases the risk that incorrect, or inconsistent, data will be entered into the company's or third party service provider's database, and increases the time necessary to make a well-informed hiring decision.

Some attempts have been made to increase the efficiency of the application process. For example, applicants can submit a resume on-line. In the typical case, an applicant views a company's website, clicks on the company's career link, attaches their resume to an email, and sends the email to the company's human resources department. However, the electronic resume may still be need to be manipulated into the correct format or the data re-entered into the company's database. Furthermore, after the company determines that the applicant meets the minimum job requirements, the applicant may still be required to complete a paper employment application. The information contained on the paper employment application must be entered by an employee into the company's database.

Attempts to create an on-line employment application have also been made. However, such on-line employment applications are very expensive and require specialized programming or web-design knowledge. The expense of such previous on-line applications is compounded by the fact the each job description may require a different on-line application.

Additionally, current on-line employment applications may be accessed by nonqualified applicants. For example, a job description may require that an applicant possess several years of experience in a similar type of job. However, the company cannot prevent applicants that do not meet this requirement from submitting applications. Thus, the company may receive an overwhelming number of applications from non-qualified applicants. In addition, current on-line applications are not linked to the third party service providers. Thus, duplicate data entry and increased processing time are still required. Furthermore, the results obtained by the third party service provider are not electronically linked to the company and, again, require duplicate data entry and increased processing time.

Thus, a need exists for a centralized system for facilitating the application process. Specifically, a need exists for a system that permits a customized, on-line employment application to be created without the need of specialized programming or web-design knowledge, that permits a company to pre-screen applicants and limit access to the customized employment application, that links applicants, companies, and third party service providers such that data entered once can be shared by each party, and that reduces the expense, manpower, and time necessary to make an informed hiring decision.

### SUMMARY

One embodiment of the present invention relates to a method for using a computer to facilitate a hiring transaction comprising configuring a customized employment application, authorizing an applicant to access the customized employment application, accepting job applicant data entered within the customized employment application by the authorized applicant, and manipulating the job applicant data.

One aspect of the present invention relates to a computer implemented method of customizing an application comprising selecting one or more question categories, each category having a plurality of application questions associated therewith, designating an order in which the selected question categories are displayed, choosing one or more application questions from within each selected question category, and generating a customized application having the selected question categories and the selected application questions arranged in the designated order.

Another aspect of the present invention relates to a computer implemented method comprising providing an access control mechanism (e.g., a public key) to an applicant, accepting preliminary data from the applicant, pre-screening the preliminary data, issuing another access control mechanism (e.g., a private key) to the applicant in response to the prescreening, accepting applicant data, and manipulating the applicant data.

Another aspect of the present invention relates to a computer implemented method comprising accepting applicant data, transmitting the applicant data to a data requester, displaying the applicant data within the customized application, assigning an applicant rating in response to the applicant data, transmitting the applicant data to a third-party service provider, creating correspondence in response to at least one of the applicant data, the applicant rating, and a third party service provider result, and transferring the applicant data to an data requester records database

Another aspect of the present invention relates to a computer implemented method of customizing a service order package comprising selecting one or more services and generating a customized service order package having the selected one or more services.

Another embodiment of the present invention relates to a method for electronically facilitating an application process comprising creating a customized application for a data requester, the customized application available via an Internet link and protected by an access control mechanism, granting access to the customized application to a specified data provider, accepting data from the specified data provider, providing an information management tool to the data requester, the information management tool being operable to manipulate the data from the specified data provider, and exchanging data between the data provider and the data requester.

The present invention relates to a system comprising a data requester computer. An applicant computer, a server, and a communications link between the data requester computer and the server and between the applicant computer and the server. The server in the present invention is programmed to enable a customized application to be created from the data requester computer, grant the applicant computer access to the customized employment application, accept applicant data submitted from the applicant computer, and enable the data requester computer to manipulate the applicant data.

The present invention relates to a computer carrying an ordered set of instructions which, when executed, performs a method comprising enabling a customized application to be created by a data requester, granting an applicant electronic access to the customized application, accepting applicant data submitted by the applicant, and enabling the data requester to manipulate the applicant data.

### BRIEF DESCRIPTION OF THE DRAWINGS

To enable the present invention to be easily understood and readily practiced, the present invention will now be described for purposes of illustration and not limitation, in connection with the following figures wherein:

FIG. 1 is a schematic illustration of a centralized application system for facilitating an employment application process according to an embodiment of the present invention.

FIG. 2 is a schematic illustration of a world-wide-web based computer network operable to facilitate the centralized application system, as shown in FIG. 1, according to an embodiment of the present invention.

FIG. 3 is a detailed schematic illustration of the server component of the world-wide-web based computer network of FIG. 2 according to an embodiment of the present invention.

FIG. 4 is a flowchart of the operational process employed by the centralized application system of FIG. 1 according to an embodiment of the current invention.

FIG. 5 is a flowchart of the operational process employed by the centralized application system of FIG. 1 according to an alternative embodiment of the current invention.

### DETAILED DESCRIPTION

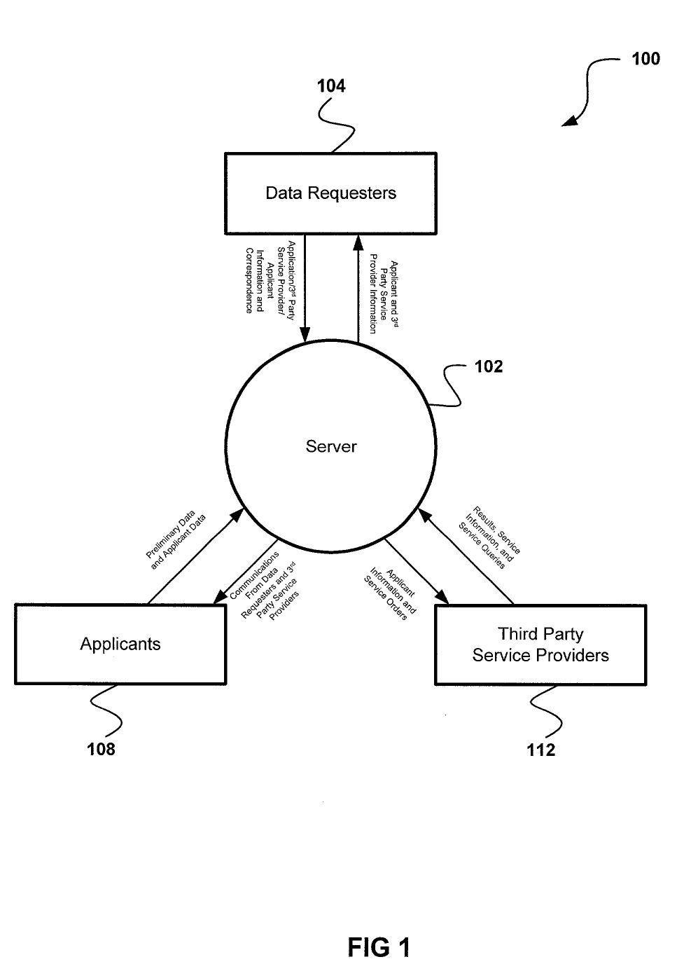

FIG. 1 is a schematic illustration of a centralized application system 100 for facilitating an application process according to an embodiment of the present invention. A data requester 104, an applicant 108, and a third party service provider 112 are linked via a server 102.

A data requester 104 refers to a person or entity (such as government agencies, banks, credit card companies, among others) who attempts to obtain information from an applicant 108. An applicant 108 refers to a person or entity that provides information to a data requester 104. A third party service provider 112 refers to a person or entity, other than the data requester 104 or applicant 108, that provides a service to the data requester 104 or the applicant 108.

The discussion of the current embodiments will be limited to a hiring process utilizing an employment application. Thus in the current embodiment, a data requester 104 refers to a company, employer, and job recruiter, among others, that attempts to obtain information from a job candidate or who is otherwise involved in the hiring, interviewing, or applicant rating processes; an applicant 108 refers to a job candidate; and a third party service provider refers to a company that completes employment related services (such as criminal *background checks, driver record checks, credit report checks, prior employment verifications, reference checks, substance abuse testing, and educational credential verifications, among others). However, it should be noted that the discussion of the current embodiments is in no way intended to restrict or limit the scope of the present invention to hiring processes or employment applications.

The server 102 is programmed to facilitate the entire application process and links the data requester 104, applicant 108 and third party service provider 112. For example, the server 102 gives the data requester 104 the ability to create customized applications, restrict access to the customized application to specific applicants 108, manipulate the data entered by an applicant 108 into the customized application, order services from a third party service provider 112, receive results from the third party service provider 112, and create correspondence for the applicant 108 and the third party service provider 112, among others.

Additionally, the server 102 gives an applicant 108 specified by the data requester 104 the ability to enter data electronically into a customized application, and communicate directly with the data requester 104, among others. Furthermore, the server 102 gives a third party service provider 112 the ability to receive applicant data directly from a data requester 104 and return service results directly to the data requester 104, among others.

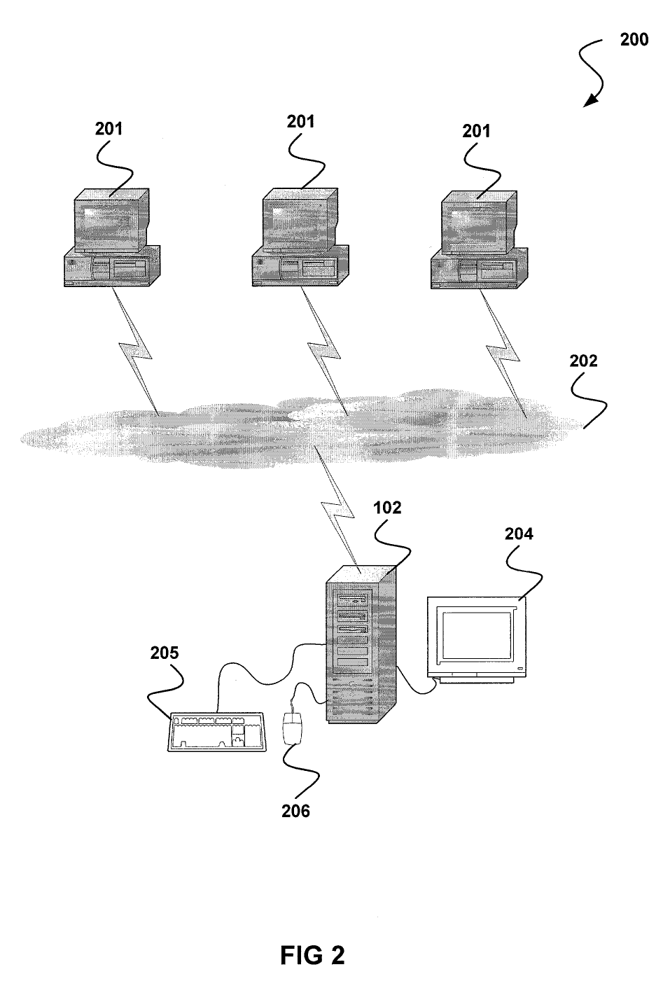

FIG. 2 is a schematic illustration of a world-wide-web based computer network 200 operable to facilitate the centralized application system 100 shown in FIG. 1, according to an embodiment of the present invention. Computer network 200 includes server 102 linked to a number of computers 201 via a network 202, such as the world-wide-web. Computers 201 may be any laptop, desktop, work-station, or other device capable of accessing the Internet or world-wide-web 202. Computers 201 include both data requester computers (e.g., computers used by a data requester 104 to access the server 102), applicant computers (e.g., computers used by an applicant 108 to access the server 102), and third party service provider computers (e.g., computers used by a third party service provider 112 to access the server 102), among others.

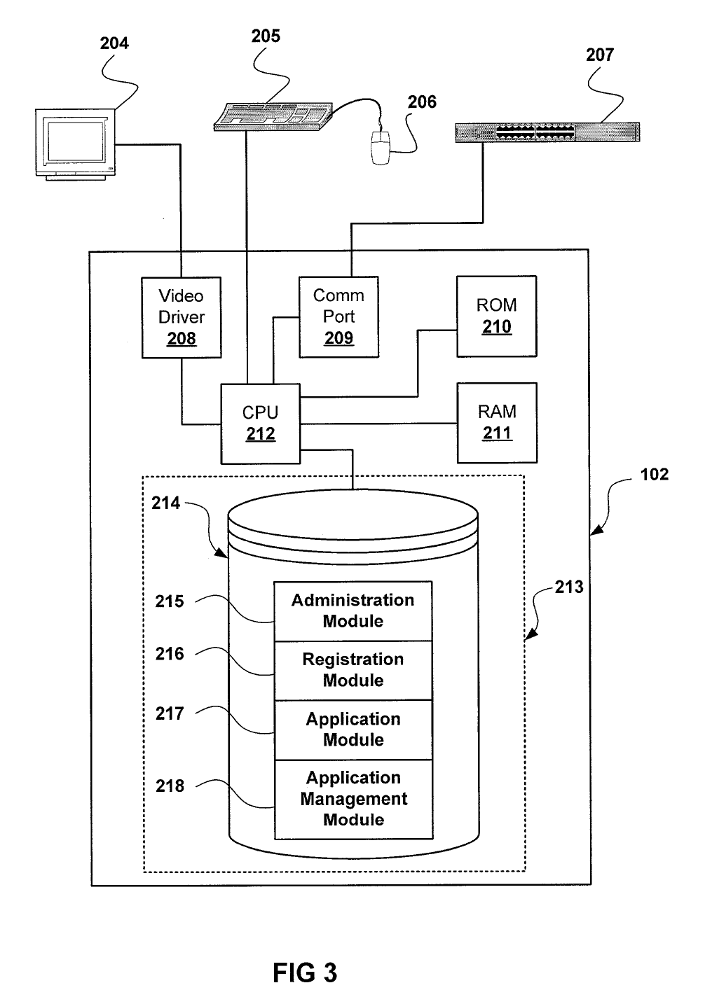

FIG. 3 is a detailed schematic illustration of server 102 of FIG. 2 according to an embodiment of the present invention. Server 102 includes a video driver 208, communications port 209, ROM 210, RAM 211, CPU 212, and storage device 213. Server 102 may also include a display 204, keyboard 205, mouse 206, as well as other input and output devices, not shown. A router 207 may be used to interface server 102 to a communications network.

Storage device 213 contains a database 214 which includes one or more programs operable to implement the functions of the centralized application system 100. The programs may be contained in one or more modules. In the current embodiment, database 214 has an application administration module 215, registration module 216, application module 217, and application management module 218. The modules (i.e., 215, 216, 217, 218) are embodied in software, preferably carried by hardware equipment (such as storage device 214) or other appropriate memory devices, and executed by CPU 212.

In the current embodiment, application administration module 215 is operable to display a menu having one or more question categories, to receive data requester input, and to select one or more of the question categories in response to the data requester input. Application administration module 215 is further operable to designate an order in which the selected question categories are displayed in response to the data requester input, to choose one or more application questions from within each of the selected question categories in response to the data requester input, and to generate a customized application having the selected question categories and the selected application questions arranged in the designated order.

Application administration module 215 is operable to select one or more services from a third party service provider 112. Selection of third party services may include displaying a menu listing one or more third party services, receiving data requester input, and designating one or more of the third party services in response to the data requester input. Application administration module 215 is further operable to generate a customized third party service order package having the selected one or more third party service. Additionally, administration module 215 is operable to create a plurality of customized third party service order packages, one or more of which can be ordered by a data requester for a specific applicant.

Registration module 216 is operable to provide an access control mechanism to the customized application. In one embodiment of the present invention, a data requester 104 gives a public data requester code or a private data requester code to an applicant 108. A data requester code refers to an identifier that links the data requester 104 to a customized application and to a specific applicant 108.

For example, a public data requester code refers to a code that is placed on the data requester's 104 website to allow all visitors to the website the opportunity to complete the customized application. The applications submitted using the public data requester code is analogous to a data requester 104 accepting general walk in applications. The applications submitted using the private data requester code, on the other hand, are analogous to a data requester only accepting applications from targeted applicants 108. After receiving the data requester code, the applicant 108 applies for a personal identification number (i.e., “PIN number”), which is issued by the registration module 216. The applicant 108 selects a password, supplies registration information (such as name, address, phone number, and email address, among others), and enters a public or private data requester code. The registration module 216 then issues a PIN number to the applicant 108.

The applicant 108 accesses the data requester's customized application by logging into the website containing the customized application. The applicant 108 must enter the data requester code, password, and PIN number to access the customized application. It should be noted that other access control methods may be used while remaining within the scope of the present invention. For example, passwords, IDs, PIN numbers, and encryption keys, etc. may be used to restrict access to the customized application.

In the current embodiment, application module 217 is operable to display a customized application having a data entry field for each selected application question, to prompt an applicant to supply applicant data within the data entry fields, and to receive the applicant data supplied to the data entry fields. The application module 217 is further operable to compare the applicant data to one or more criteria, to prompt the applicant to re-enter the applicant data which does not satisfy the one or more criteria, to validate the applicant data which satisfies the one or more criteria, and to store the validated applicant data within a database.

In the current embodiment, application management module 218 is operable to receive data requester input, to display the applicant data within the customized application, to assign a value to the applicant data in response to the data requester input, and to produce an applicant rating in response to at least one of the assigned value and the data requester input. The application management module 218 is further operable to create correspondence in response to at least one of the applicant rating, the applicant data, and the data requester input. In the current embodiment, correspondence refers to offer of employment letters, rejection letters, adverse action letters (e.g., a letter notifying an applicant 108 that a criminal background check has returned an adverse result, etc.), among others. It should be noted that other types of correspondence may be created while remaining within the scope of the present invention.

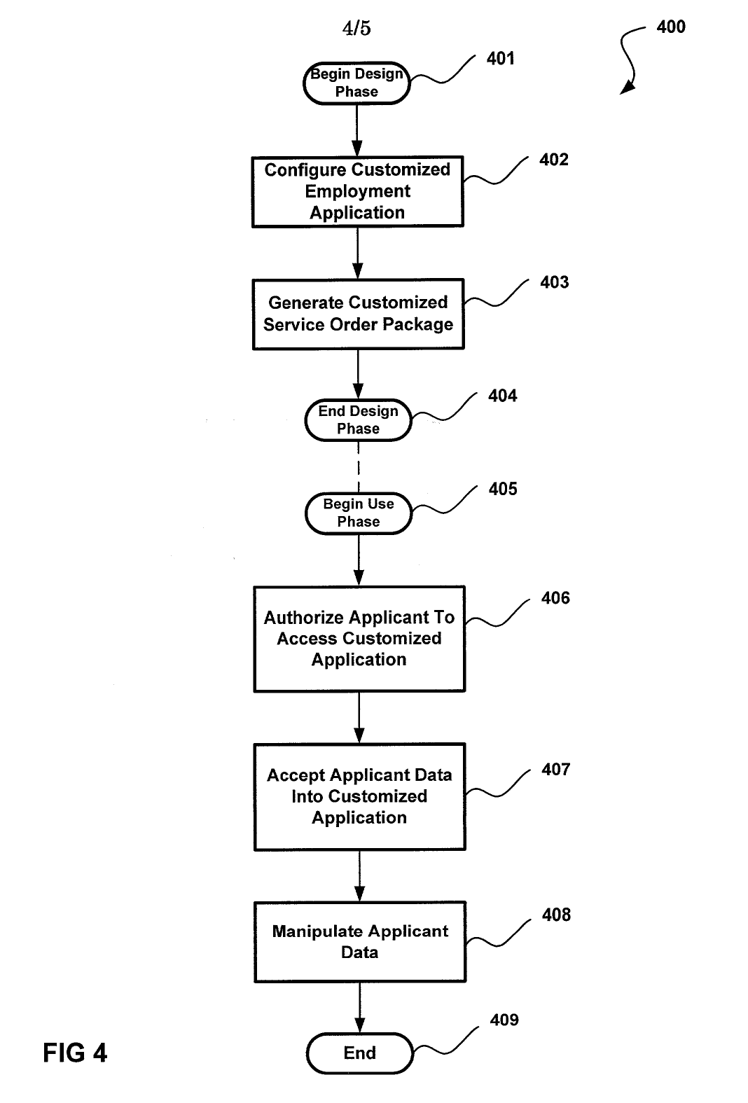

FIG. 4 is a flowchart of the operational process employed by the centralized application system of FIG. 1 according to an embodiment of the current invention. Operation 401 initiates operational process 400. In the current embodiment, operation 400 is initiated when a data requester 104 sets up an account with the server administrator. Account information typically includes the name, address, phone number, and data requester's 104 authorized users, among others. After an account is established, the server administrator issues the data requester a public data requester code and a data requester code, as discussed in conjunction with FIG. 3. The process continues with operation 402 after operational process 400 is initialized by operation 401.

Operation 402 configures the customized employment application. In the current embodiment, the data requester 104 accesses the server 102 via an internet webpage. The data requester 104 selects one or more question categories contained on server 102. Each of the question categories contains a plurality of employment application questions associated therewith. Next, the data requester 104 designates the order in which the selected question categories are to be displayed. The data requester 104 then selects the specific questions, within each question category, that are to be included on the customized application. It should be noted that the data requester 104 may enter additional questions that are not contained within a question category. After the application questions are selected, the server 102 generates a customized employment application having the selected question categories and the selected employment application questions, arranged in the designated order.

The customized employment application generated in operation 402 resides on the server 102. The customized employment application is associated with the data requester 104 by the data requester code. Operation 402 also issues an internet address associated with the customized application, a public key, and private key, among others, to the data requester 104. The data requester 104 may then place a hyper link to the customized application on their own website or may only disclose the web address to specific applicants, among others. The process continues with operation 403 after operational process 402 is completed.

Operation 403 generates a customized service order package. In the current embodiment, the data requester 104 accesses the server 102 via an internet webpage. The data requester 104 selects one or more services (for example a criminal background check, driving record check, etc.) offered by a third party which are to be included within a service order package. A customized service order package, containing the selected services, is created. The data requester 104 may assign a name or other identifier to the customized service order package. The data requester 104 may create multiple customized service order packages.

In the current embodiment, a data requester 104 creates one or more customized service order packages for each job description or job category. For example, a data requester 104 may wish to create a customized service order package for the company's truck drivers. The data requester 104 may decide that company truck drivers must undergo a criminal background check, driving record check, and drug screening test. Thus, the data requester 104 selects these services from the menu and a customized service order package containing the criminal background, driving records, and drug screening services is generated. For the company's administrative assistants, the data requester 104 may decide that a driving records check is not required, however, an education credential verification should be completed. Thus the data requester 104 selects the criminal background check, education credential verification, and drug screening services from the menu and a customized service order package containing these services is generated.

The configuring of a customized employment application will typically take place once per job opening, job description, or job type at what may be called the “design phase”. The generation of the customized service order packages may also be completed during the “design phase”. It should be noted that order of operation 402 and operation 403 may be interchanged while remaining within the scope of the present invention. After the customized application is configured and the customized service order packages are generated, operation 404 terminates the “design phase”. Thereafter, operation 405 initiates a “run phase”, in which users will use the customized employment application and data requesters 104 may update the customized employment application. Although typically completed during the “design phase”, customized service order packages may also be created or updated during the “run time.”

Operation 406 authorizes an applicant 104 to access the customized application. In the current embodiment, an interested applicant 108 selects the hyperlink on the data requester's website. Mandatory disclaimer and disclosures are displayed and the applicant is prompted to continue after the disclaimers and disclosures have been read. The applicant 108 then logs into the customized application. The applicant 108 must have a PIN number to access the customized application. The applicant 108 uses the data requester code (either public or private), selects a password, and requests a PIN number (as discussed in conjunction with FIG. 3). If the applicant 108 does not have a data requester code, the applicant 108 will not be issued a PIN number to access the customized application. If the applicant 108 is issued a PIN number, the process then continues with operation 407.

Operation 407 accepts an applicant's data into the customized employment application. In the current embodiment, the applicant 108 accesses the customized application by logging in using the selected password, data requester code, and issued PIN number. The applicant 108 answers the questions previously selected by the data requester 104 during operation 402. The applicant 108 may fill out the entire application at one time, or may temporarily save a partially completed application and return later to supply the missing data. Once all of the required data is entered, the applicant 108 submits the completed customized application for acceptance by the server 102.

In the current embodiment, the applicant data is be required to meet specific criteria before being accepted. For example, if a question asks for the applicant's 108 phone number, a criterion may be established that only numerals be accepted as a response. All data meeting the applicable criterion is accepted, whereas data that does not meet the applicable criterion is returned to the applicant 108 for correction. Furthermore, after the application is completed, the applicant is given the opportunity to print a copy of the completed application. The process then continues will operation 408.

Operation 408 manipulates the data as required to facilitate the application process. In the current embodiment, the operation 408 notifies the data requester 104 (when the data requester 104 logs into the website) that the server 102 has received the applicant's 108 completed application. The data requester 104 accesses the completed application through the website by clicking on a “review applications” link. A list of completed customized applications related to the specific data requester 104 is displayed.

The data requester 104 selects a completed application to review. The data requester 104 can review the applicant's 108 data, send the completed application to another authorized user, assign a rating to the applicant data, order third party services, and generate the appropriate correspondence using the applicant data, among others.

For example, a first data requester 104 may determine that the applicant 108 has qualities desired by the company, however, the applicant does not meet the requirements for the job that the first data requester 104 is attempting to fill. The first data requester 104 give the applicant 108 a favorable rating 108 and forward his application electronically to another data requester 104 in another department. The second data requester 104 may find the applicant 108 is highly qualified to fill the company's open truck driver position. The second data requester 104 decides to order the necessary third party services. The second data requester 104 merely clicks on an “order service” link and an “order service” screen is displayed. The “order service” screen contains a menu having the customized service order packages previously created by the data requesters 104 (as discussed in conjunction with operation 403). The second data requester 104 selects one or more of the customized service order packages (such as the one established for the truck driver job description), or selects “a la carte” from a services menu.

Once the desired service selections are made, the second data requester 104 submits the service order request. The service order request, containing the desired service to be completed, and the applicant data is electronically sent from the server to the third party service provider 112. In this manner, the data requester 104 is only required to click once to transmit the service order and related applicant data, and the third party service provider 112 is not required to re-enter applicant data.

The third party service provider 112 may then enter the results of the third party service request into the server 102. Once the third party results are entered, the data requester 104 is notified that the results are available. The data requester 104 clicks on a “review results” link, which displays a list of completed applications that have results available.

The data requester 104 can forward the results to another data requester 104 or, depending on the results of the background check, generate the necessary correspondence for an offer or rejection of employment. The correspondence can be sent to the applicant by merely clicking on a “contact applicant” link.

In both the “order service” and “contact applicant” scenarios, data is sent directly to the third party service provider 112 and the applicant, respectively, through the website. The third party service provider 112 and the applicant can also reply directly to the data requester 104, or to each other, via the website. In this manner, data is not required to be re-entered by the data requester 104, the third party service provider 112, or the applicant.

Additionally, the data requester 104 can delete an applicant's data from the centralized system, download a applicant's data to create an archive (e.g., save the applicant's data to the data requester computer 201), or transfer the applicant's data to another computer or storage device, among others. After operation 408, operational process 400 is then terminated by operation 409. Process 405-408 may be carried out in parallel if multiple applicants 108 use the system or serially as applicants 108 access the system. Unlike process 402, processes 405-408 will be carried out numerous times for each available job.

One aspect of the present invention is the computer implemented method for customizing the application. This customizing method may be used for numerous types of applications, not just employment applications. The method comprises selecting one or more question categories, each category having a plurality of application questions associated therewith, designating an order in which the selected question categories are displayed, choosing one or more application questions from within each selected question category, and generating a customized application having the selected question categories and the selected application questions arranged in the designated order.

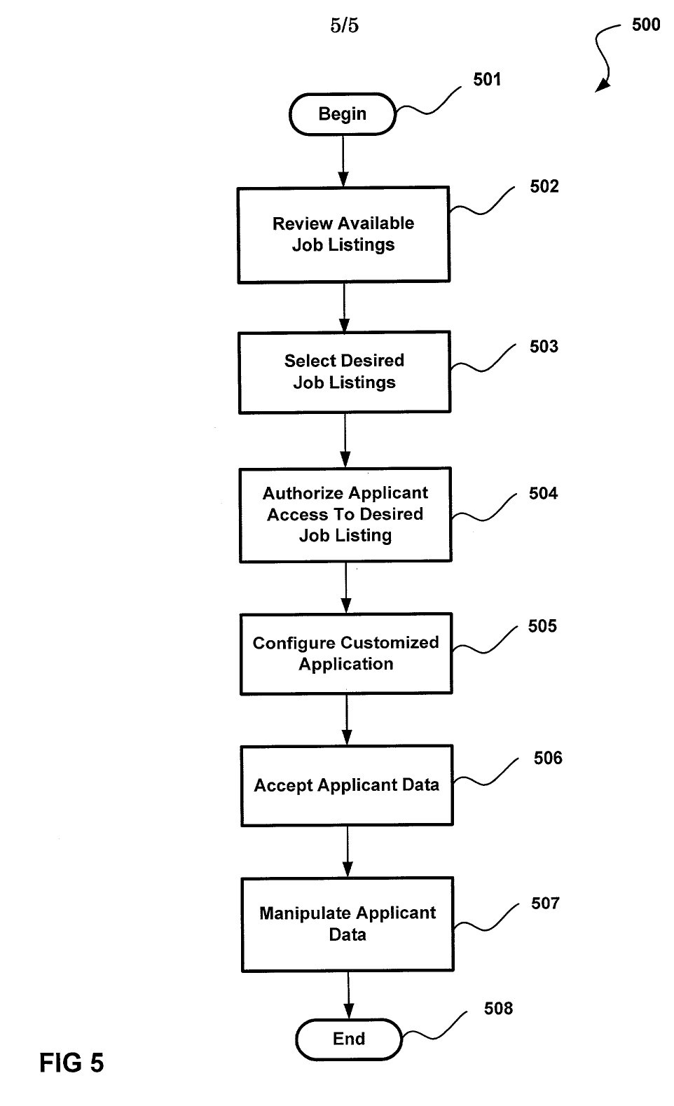

FIG. 5 is a flowchart of the operational process 500 employed by the centralized application system of FIG. 1 according to an alternative embodiment of the current invention. Operational process 500 is initiated by operation 501. In operation 501, an applicant 108 logs onto a website containing job listings from numerous data requesters 104. In operation 502, the applicant 108 reviews the available jobs listed on the website.

In operation 503 the applicant 108 selects the job listings (from different data requesters 104) to which he wishes to apply. After the applicant selects the desired job listings in operation 503, operation 504 authorizes the applicant 108 to select the desired job listings.

In operation 505 that the applicant 108 selects a password and enters the data requester code for each job listing that the applicant 108 wishes to apply. The applicant 108 is issued a single PIN number, as discussed above in conjunction with Operation 405, to access the customized application that will be completed. The applicant 108 must submit the data requester code from each authorizing data requester 104 (i.e., those data requesters 104 for which a data requester code has been given), for each job listing. In other words, the applicant 108 can only select those job listings for which he has a data requester code.

Operation 505 configures a single customized job application for all of the selected and authorized job listings. The customized job application meets each data requesters' 104 requirements for the job listing selected. For example, if one data requester 104 requires an applicant's 108 date of birth, but a second data requester 104 does not, the customized application will contain a data of birth question for the applicant 108 to complete. The date of birth information supplied by the applicant 108, however, will only be sent to the data requester 104 requiring such information.

Once the customized application is configured by operation 505, operation 506 accepts applicant data as discussed in conjunction with operation 407 in FIG. 4. It should be noted that applicant data is sent only to those authorizing data requesters 104. After the authorizing data requester 104 receives the applicant data in operation 506, operation 507 permits the authorizing data requester to manipulate the data as discussed in conjunction with operation 408 in FIG. 4. Operation 508 terminates operational process 500.

Appendix A, entitled “HireAPP Online Employment Application Recruiter Functions—User Guide”, Appendix B, entitled “HireAPP Online Application—Training For Human Resources Professionals”, Appendix C, entitled “HireAPP Online Employment Application Recruiter Functions”, and Appendix D is entitled “Administration Functions for HireAPP”, each attached hereto, are hereby incorporated by reference in their entirety.

The above-described embodiments of the invention are intended to be illustrative only. Numerous alternative embodiments may be devised by those skilled in the art without departing from the scope of the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method, comprising:
customizing an employment application;
authorizing an applicant to access said customized employment application;
accepting job applicant data entered within said customized employment application by said authorized applicant; and
manipulating said job applicant data.

2. The method of claim 1 wherein said customizing further comprises:
selecting one or more question categories, each of said question categories having a plurality of employment application questions associated therewith;
designating an order in which said selected question categories are displayed;
choosing one or more employment application questions from within each of said selected question categories; and
generating a customized employment application having said selected question categories and said selected employment application questions arranged in said designated order.

3. The method of claim 1 wherein said authorizing an applicant to access said customized employment application further comprises:
providing a data requester code to said applicant;
accepting an applicant password; and
issuing a personal identification number to said applicant.

4. The method of claim 1 wherein said accepting job applicant data entered by said applicant further comprises:
providing a data entry field for each selected employment application question in said customized employment application;
comparing said job applicant data to one or more criteria;
validating said job applicant data that satisfies said one or more criteria; and
storing said validated job applicant data within a database.

5. The method of claim 1 wherein said manipulating said job applicant data further comprises at least one of:
transmitting said job applicant data to a data requester;
displaying said job applicant data within said customized employment application;
assigning an applicant rating in response to said job applicant data;
ordering a third party service from a third-party service provider;
creating hiring correspondence in response to at least one of said job applicant data, said applicant rating, and a third party service provider result;
creating rejection correspondence in response to at least one of said job applicant data, said applicant rating, and said third party service provider result;
creating adverse-action correspondence in response to at least one of said job applicant data, said applicant rating, and said third party service provider result;
deleting said job applicant data; and
transferring said job applicant data to a data requester records database.

6. A computer implemented method of customizing an application, comprising:
selecting one or more question categories, each of said question categories having a plurality of application questions associated therewith;
designating an order in which said selected question categories are displayed;
choosing one or more application questions from within each of said selected question categories; and
generating a customized application having said selected question categories and said selected application questions arranged in said designated order.

7. The computer implemented method of 6 further comprising entering additional questions that are not contained within said question categories.

8. A computer implemented method, comprising:
providing a data requester code to said applicant;
accepting an applicant password;
issuing a personal identification number to said applicant;
accepting applicant data; and
manipulating said applicant data.

9. A computer implemented method, comprising:
accepting applicant data;
transmitting said applicant data to a data requester;
displaying said applicant data within a customized application;
assigning an applicant a rating in response to said applicant data;
transmitting said applicant data to a third-party service provider;
creating correspondence in response to at least one of said applicant data, said applicant rating, and a third party service provider result; and
transferring said applicant data to a data requester records database.

10. A method for electronically facilitating an application process comprising:
creating a customized application for a data requester, said customized application available via an Internet link protected by an access control mechanism;
granting access to said customized application to a specified data provider;
accepting data from said specified data provider;
providing an information management tool to said data requester, said information management tool being operable to manipulate said data from said specified data provider, and exchanging data between said data provider and said data requester.

11. The method of claim 10 further comprising exchanging data between said data requester and a third party service provider.

12. The method of claim 10 wherein said creating a customized application further comprises:
selecting one or more question categories, each of said question categories having a plurality of application questions associated therewith;
designating an order in which said selected question categories are displayed;
choosing one or more application questions from within each of said selected question categories; and
generating a customized application having said selected question categories and said selected application questions arranged in said designated order.

13. The method of claim 11 wherein said creating a customized application further comprises entering additional questions that are not contained within said question categories.

14. The method of claim 10 wherein said accepting data from said specified data provider further comprises:
providing a data entry field for each selected application question in said customized employment application;
comparing data entered by said specified data provider to one or more criteria;
validating said data entered by said specified data provider; and
storing said validated data within a database.

15. The method of claim 10 wherein providing an information management tool to said data requester further comprises:
listing one or more specified data providers;
rating each of said one or more specified data providers;
sharing data from said one or more specified data providers with said third party service provider computer;
transferring data from said one or more specified data providers to a records database; and
creating correspondence relative to said data.

16. A system, comprising:
a data requester computer;
a applicant computer;
a server; and
a communications link between said data requester computer and said server and between said applicant computer as said server, said server programmed to:
enable a customized application to be created from said data requester computer;
grant said applicant computer access to said customized employment application;
accept applicant data submitted from said applicant computer; and
enable said data requester computer to manipulate said applicant data.

17. The system of claim 16 further comprising a third party service provider computer connected to said server by said communications link.

18. The system of claim 16 wherein said server programmed to enable a customized application to be created is further programmed to:
select one or more question categories, each of said question categories having a plurality of application questions associated therewith;
designate an order in which said selected question categories are displayed;
choose one or more application questions from within each of said selected question categories; and
generate a customized application having said selected question categories and said selected application questions arranged in said designated order.

19. The system of claim 16 wherein said server programmed to grant said applicant computer access to said customized application is further programmed to:
providing a data requester code to said applicant;
accepting an applicant password; and
issuing a personal identification number to said applicant.

20. The system of claim 16 wherein said server programmed to accept applicant data submitted by said applicant computer is further programmed to:
provide a data entry field for each selected application question in said customized application;
compare said applicant data to one or more criteria;
validate said applicant data that satisfies said one or more criteria; and
store said validated applicant data within a database.

21. The system of claim 16 wherein said server programmed to enable said data requester computer to manipulate said applicant data is further programmed to:
transmit said applicant data to another data requester computer;
display said applicant data within said customized application;
assign an applicant rating in response to said applicant data;
transmit said applicant data to a third-party service provider computer;
create correspondence in response to at least one of said applicant data, said applicant rating, and a third party service provider result; and
transfer said applicant data to a records database.

22. The method of claim 16 wherein said server programmed to enable said data requester computer to manipulate said applicant data is further programmed to:
list one or more applicants, each applicant having submitted applicant data;
rate each of said one or more applicants;
share applicant data from said one or more applicants with a third party service provider computer; and
create correspondence relative to said applicant data for each of said one or more applicants.

23. A computer carrying an ordered set of instructions which, when executed, perform a method, comprising:
enabling a customized application to be created by a data requester;
granting an applicant electronic access to said customized application;
accepting applicant data submitted by said applicant; and
enabling said data requester to manipulate said applicant data.

24. The computer of claim 23 wherein said set of instructions includes instructions comprising an application administration module operable to:
display a menu having one or more question categories;
receive data requester input;
select one or more of said question categories in response to said data requester input;
designate an order in which said selected question categories are displayed in response to said data requester input;
choose one or more application questions from within each of said selected question categories in response to said data requester input; and
generate a customized application having said selected question categories and said selected application questions arranged in said designated order.

25. The computer of claim 23 wherein said set of instructions includes instructions comprising an applicant management module operable to:
receive data requester input;
display said applicant data within said customized application;
assign a value to said applicant data in response to said data requester input;
transmit applicant data to another data requester;
produce an applicant rating in response to at least one of said assigned value and said data requester input; and
create correspondence in response to at least one of said applicant rating, said applicant data, and said data requester input.

26. The computer of claim 23 wherein said set of instructions includes instructions comprising an application module operable to:
display a customized application having a data entry field for each selected application question;
prompt an applicant to supply applicant data within said data entry fields;
receive said applicant data supplied to said data entry fields;
compare said applicant data to one or more criteria;
prompt said applicant to re-enter said applicant data which does not satisfy said one or more criteria;
validate said applicant data which satisfies said one or more criteria; and
store said validated applicant data within a database.

27. The computer of claim 23 wherein said set of instructions includes instructions comprising a registration module operable to:
providing a data requester code to said applicant;
accepting an applicant password; and
issuing a personal identification number to said applicant.

28. The device of claim 25 wherein said applicant management module contains instructions further operable to:
transmit said applicant data to a third-party service provider;
receive a third-party service provider input; and
create correspondence in response to said third party service provider input.

29. A method, comprising:
selecting one or more job listings;
authorizing an applicant access said customized employment application;
customizing an employment application in response to said selecting said job listings and authorization said applicant;
accepting job applicant data entered within said customized employment application by said authorized applicant; and
sending said application data to an authorizing data requester.

30. The method of claim 29 further comprising:
manipulating said job applicant data.

31. The method of claim 29 wherein customizing further comprising:
selecting one or more question categories, each of said question categories having a plurality of employment application questions associated therewith;
choosing one or more employment application questions from within each of said selected question categories, said one or more employment application questions meeting each of said job listings requirements; and
generating a customized employment application having said selected question categories and said selected employment application questions.

32. The method of claim 29 wherein said authorizing an applicant to access said customized employment application further comprises:
providing a data requester code to said applicant;
accepting an applicant password; and
issuing a personal identification number to said applicant.

33. The method of claim 29 wherein said accepting job applicant data entered by said applicant further comprises:
providing a data entry field for each selected employment application question in said customized employment application;
comparing said job applicant data to one or more criteria;
validating said job applicant data that satisfies said one or more criteria; and
storing said validated job applicant data within a database.

34. The method of claim 29 wherein said manipulating said job applicant data further comprises at least one of:
transmitting said job applicant data to a data requester;
displaying said job applicant data within said customized employment application;
assigning an applicant rating in response to said job applicant data;
transmitting said job applicant data to a third-party service provider;
creating hiring correspondence in response to at least one of said job applicant data, said applicant rating, and a third party service provider result;
creating rejection correspondence in response to at least one of said job applicant data, said applicant rating, and said third party service provider result;
creating adverse-action correspondence in response to at least one of said job applicant data, said applicant rating, and said third party service provider result; and
transferring said job applicant data to a data requester records database.

35. A computer implemented method of customizing a third party service order package, comprising:
selecting one or more third party services; and
generating a customized service order package having said selected one or more services.

36. The computer implemented method of claim 35 further comprising:
providing applicant data related to said one or more services;
ordering said customized service order package from a third party.

37. The computer implemented method of claim 35 further comprising repeating said selecting one or more services and said generating a customized service order package, said repeating creating a plurality of customized service order packages.

38. The computer implemented method of claim 37 further comprising:
providing applicant data related to said one or more services;
ordering one or more of said plurality of customized service order packages.

39. The computer implemented method of claim 35 wherein said selecting one or more services further comprises:
displaying a menu having said one or more services categories;
receiving a data requester input; and
designating said one or more services in response to said data requester input.
